(19) United States
(12) Patent Application Publication
(10) Pub. No.: US 2004/0112183 A1
(43) Pub. Date: Jun. 17, 2004

(54) Screw gun to feed and drive collated screws

(76) Inventors: San-I Huang, Taichung (TW); Chin-Chi Chen, Taichung (TW)

Correspondence Address: VENABLE, BAETJER, HOWARD AND CIVILETTI, LLP, P.O. BOX 34385, WASHINGTON, DC, 20043-9998, US

(21) Appl. No.: 10/320,553

(22) Filed: Dec. 17, 2002

(51) Int. Cl. B25B 23/06

(52) U.S. Cl. 81/434

(57) ABSTRACT

A screw gun to feed and drive collated screws includes a gun-shaped body with an opening, a motor, a screwdriver assembly, a bracket and a screw feed assembly. The screwdriver assembly is mounted in the body and includes a transmission assembly, a screwdriver and a clutch assembly. The transmission assembly is rotated by the motor, and the screwdriver is attached to the transmission assembly. The clutch assembly is mounted in the transmission assembly so the screwdriver will not be rotated by the transmission assembly without an axial load. The bracket is mounted in the opening of the body, and the screw feed assembly is slidably mounted in the bracket. In operation, the screw gun is pressed against a workpiece and the screw feed assembly slides into the body and indexes a screw for the screwdriver to screw.

### BACKGROUND OF THE INVENTION

1. Field of the Invention

The present invention relates to a screw gun, and more particularly to a screw gun with a clutch assembly to feed and drive collated screws, which is safe to operate and automatically feeds the collated screws.

2. Description of Related Art

Screws or threaded fasteners are used widely to fasten objects together or attach one object to the other. Cordless or electrical screwdrivers are often used to drive screws to save time and increase work efficiency. Typical electrical screwdrivers, called screw guns, use collated screws to increase the work efficiency. A conventional screw gun has a body, a power device, a trigger and a screwdriver. The power device is mounted in the body and provides power to rotate the screwdriver. The trigger is pivotally mounted in the body and switches the power of the power device on when the trigger is squeezed. The screwdriver is attached to the power device and is rotated by the power device.

When an operator squeezes the trigger, the screwdriver rotates to screw a screw into some object. The conventional screw gun still has some shortcomings. When the operator has finished screwing one screw, the operator must release the trigger to stop the screwdriver from rotating. To screw the next screw, the operator squeezes the trigger again. If many screws need to be screwed, repeatedly releasing and squeezing the trigger is really inconvenient.

Moreover, if the operator touches the trigger inadvertently, the screwdriver may rotate suddenly and cause some damage or hurt somebody.

To overcome the shortcomings, the present invention provides an improved screw gun to mitigate or obviate the aforementioned problems.

### SUMMARY OF THE INVENTION

A screw gun to feed and drive collated screws comprises a gun-shaped body, a power assembly, a screwdriver assembly, a bracket and a screw feed assembly.

The body has an opening, and the power assembly is mounted in the body. The power assembly has a motor with a drive shaft that provides rotating power.

The screwdriver assembly comprises a transmission assembly, a screwdriver and a clutch assembly. The transmission assembly is rotatably mounted in the body and comprises a transmission shaft, a drive wheel and a spindle. The transmission shaft is coupled to the drive shaft of the motor and rotated by the drive shaft. The drive wheel with two drive blocks is slidably attached to the transmission shaft and rotates with the transmission shaft.

The spindle with an inside end and an outside end is rotatably and slidably mounted in the body, and two drive wings are formed diametrically on the inside end of the spindle. Each drive wing is adapted to abut the drive block. The screwdriver with a tip is attached to the outside end of the spindle.

The clutch assembly comprises a biasing member mounted between the drive wheel and the spindle to separate the drive block of the drive wheel from the drive wing of the spindle. The bracket is securely mounted in the opening of the body. The screw feed assembly comprises a adjustable body that is slidably mounted in the bracket and adapted to feed collated screws as the adjustable body moves toward the body.

Consequently, the screwdriver is not rotated by the transmission shaft without an axial load that pushes the spindle toward the transmission shaft. When the axial load is applied, the drive wings of the spindle abut the drive blocks of the transmission shaft so the transmission shaft rotates the screwdriver.

The main objective of the invention is to provide a safe screw gun to drive and automatically feed collated screws.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a screw gun in accordance with the present invention;

FIG. 2 is another perspective view of the screw gun in FIG. 1;

FIG. 3 is an operational, cross sectional side plan view of the screw gun in FIG. 1;

FIG. 4 is an enlarged, cross sectional top plan view of the screwdriver assembly of the screw gun in FIG. 1;

FIG. 5 is an exploded perspective view of the screwdriver assembly in FIG. 4;

FIG. 6 is an enlarged operational side plan view of the ratchet assembly of the screw gun in FIG. 1;

FIG. 7 is a cross sectional top plan view of the ratchet assembly in FIG. 6;

FIG. 8 is an operational, cross sectional top plan view of the screwdriver in the screw gun in FIG. 1 engaging and driving a screw;

FIG. 9 is a cross sectional front plan view of the screw length assembly along 9-9 line in FIG. 1;

FIG. 10 is an operational, cross sectional top plan view of the screwdriver assembly in FIG. 4 showing the drive wheel rotating the spindle; and

FIG. 11 is an operational, cross sectional top plan view of the ratchet assembly in FIG. 7 showing the driver disengaged from the ratchet wheel.

### DETAILED DESCRIPTION OF PREFERRED EMBODIMENT

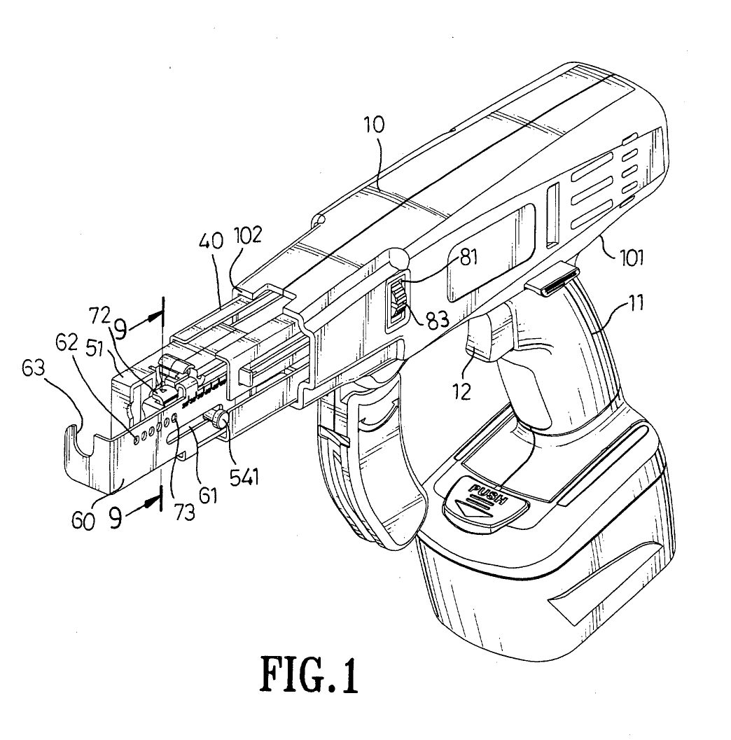

With reference to FIGS. 1 to 3 and 8, the screw gun in accordance with the present invention includes a gun-shaped body (10), a power assembly (not numbered), a screwdriver assembly (20), a bracket (40), a screw feed assembly (not numbered) and a screw depth adjustment assembly (80).

The body (10) has a bottom (101), a front opening (102), a right side (not numbered), a left side (not numbered), a handle (11) and a rear end (not numbered). The handle (11) has a distal end and is formed at the bottom (101) of the body (10) near the rear end. A trigger (12) is slidably mounted in the handle (11) at the bottom (101) of the body (10).

The power assembly includes a motor (13), a switch (14) and a power source (not numbered). The motor (13) has a drive shaft (131) with a keyed end (not numbered) rotatably mounted in the motor (13). The motor (13) is electrically connected to the switch (14) and the power source in series. The switch (14) is mounted in the handle (11) and has a pushbutton (not numbered) adapted to be pressed by the trigger (12). The power source can be a battery (not shown) or an external power source (not shown). The battery is mounted in a battery housing (not numbered) attached to the distal end of the handle (11). The external power source such as an electrical outlet (not shown) is connected to the screw gun through a power cord (not shown). The power source provides electricity to the motor (13) to rotate the drive shaft (131).

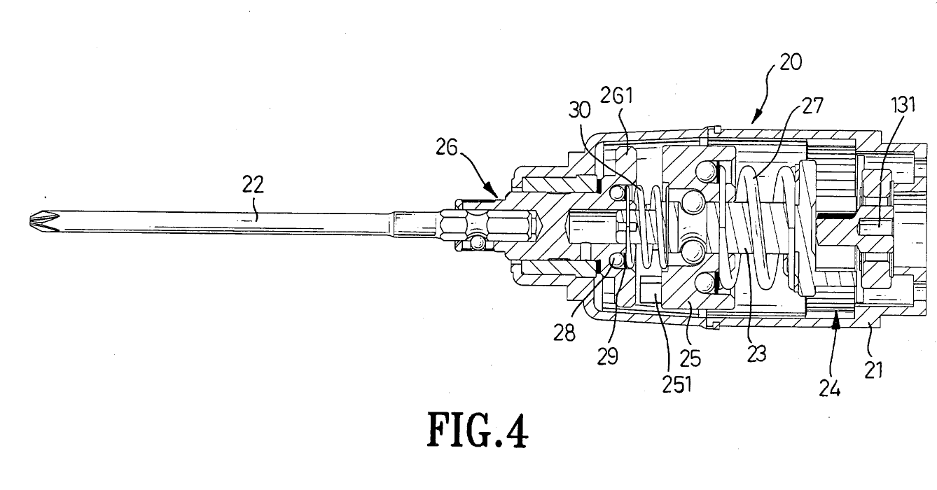

With further reference to FIG. 4, the screwdriver assembly (20) includes a housing (21), a transmission assembly (not numbered), a screwdriver (22) and a clutch assembly (not numbered). The housing (21) is cylindrical and has a rear end (not numbered) and a front end (not numbered). The rear end of the housing (21) is attached axially to the motor (13), and the keyed end of the drive shaft (131) of the motor (13) extends into the housing (21) from the rear end of the housing (21). The front end is opposite from the rear end of the housing (21).

The transmission assembly is rotatably mounted in the housing (21) and includes a transmission shaft (23), a transmission gear set (24), a drive wheel (25) and a spindle (26). The transmission shaft (23) is rotatably mounted in the housing (21) with the transmission gear set (24) and has an elongated end (not numbered) facing the front end of the housing (21). The transmission shaft (23) is coupled to the keyed end of the drive shaft (131) of the motor (13) so the drive shaft (131) rotates the transmission shaft (23).

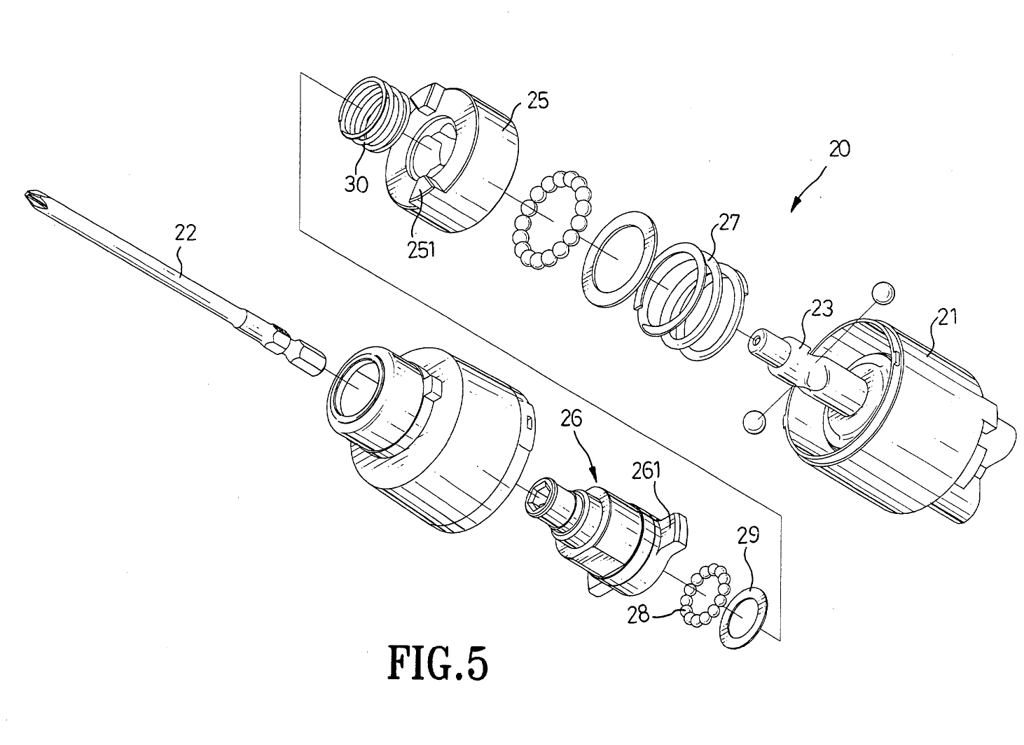

With further reference to FIG. 5, the drive wheel (25) is movably attached to the transmission shaft (23). The drive wheel (25) has a central hole (not numbered) and a drive face (not numbered). The elongated end of the transmission shaft (23) passes through the central hole in the drive wheel (25). The drive face of the drive wheel (25) faces toward the front end of the housing (21) and has an outer edge. A coil spring (27) is mounted between the drive wheel (25) and the transmission gear set (24). Two drive blocks (251) are formed on diametrically opposite outer edges of the drive face of the drive wheel (25).

The spindle (26) is rotatably and slidably mounted in the front end of the housing (21). The spindle (26) has an inside end (not numbered) with an outer periphery and an outside end (not numbered). The inside end is inside the housing (21) facing toward the drive wheel (25), and the outside end protrudes out of the housing (21). Two drive wings (261) are formed on diametrically opposite sides of the periphery of the inside end of the spindle (26). An axial blind hole (not numbered) and a concentric annular recess (not numbered) are defined in the inside end of the spindle (26). The elongated end of the transmission shaft (23) is slidably mounted in the blind hole in the spindle (26). A multi-faceted hole (not numbered) is defined axially in the outside end of the spindle (26). The screwdriver (22) has a corresponding multi-faceted end (not numbered) and a tip (not numbered), and the multi-faceted end is mounted in the multi-faceted hole in the spindle (26). The multi-faceted end is held in the multi-faceted hole in the spindle (26) by a ball and spring combination (not numbered) so the spindle (26) rotates the screwdriver (22).

The clutch assembly includes ball bearings (28), a washer (29) and a biasing member (30). The ball bearings (28) are mounted in the concentric annular recess in the spindle (26), and the washer (29) is mounted in the concentric annular recess in the spindle (26) to cover the ball bearings (28) and hold them in the concentric annular recess. The biasing member (30) such as a spring is mounted around the elongated end of the transmission shaft (23) between the washer (29) and the drive face of the drive wheel (25). With no axial pressure applied to the front end of the spindle (26), the biasing member (30) keeps the drive face of the drive wheel (25) and the inside end of the spindle (26) separated from each other so the drive blocks (251) on the drive wheel (25) cannot engage the drive wings (261) on the spindle (26).

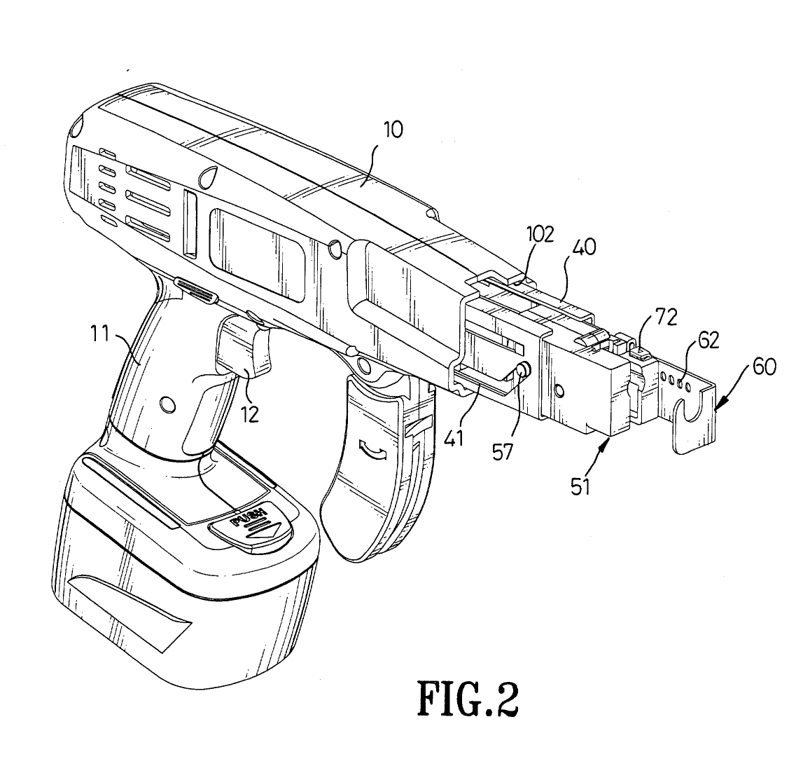

With reference to FIG. 2, the bracket (40) is securely mounted in and protrudes through the opening (102) in the body (10). The bracket (40) comprises two symmetric half-bodies (not numbered). The half-bodies are mounted in the right side and left side of the body (10), respectively, and a guide slot (41) is defined in the half-body in the left side.

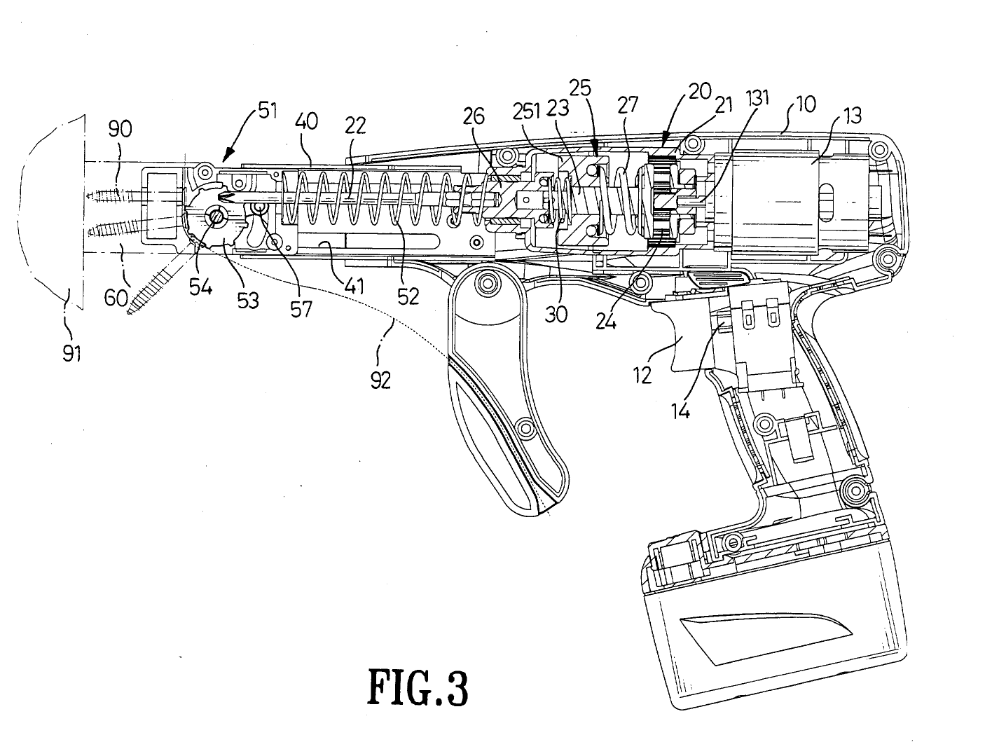

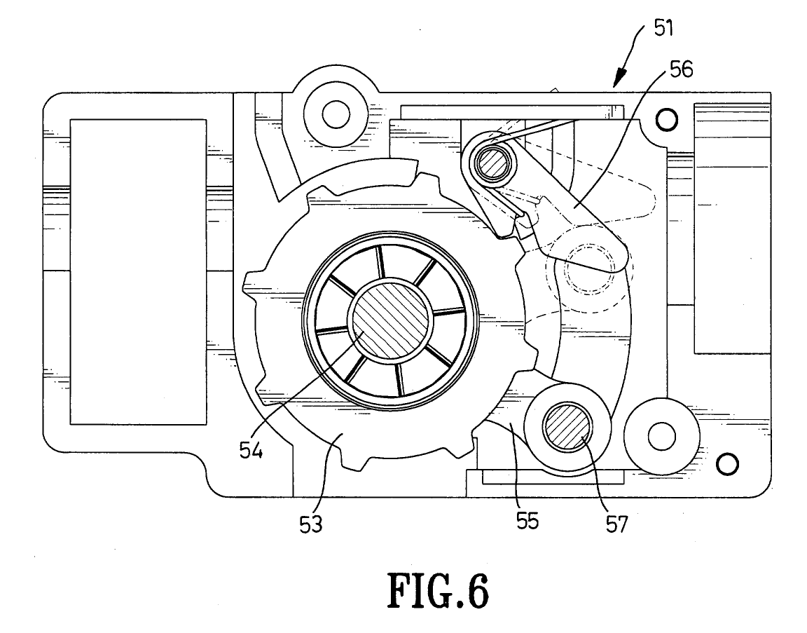

With reference to FIGS. 3, 6 and 7, the screw feed assembly is mounted axially in the bracket (40) and includes an adjustable body (51), a spring (52), a screw length assembly and a ratchet assembly. The adjustable body (51) has two half-shells, a top, a right sidewall and a left sidewall and is slidably mounted in the bracket (40). The right sidewall of the adjustable body (51) corresponds to the right side of the body (10), and the left sidewall of the adjustable body (51) corresponds to the left side of the body (10). The half-shells house the ratchet assembly that is mounted in the adjustable body (51). The spring (52) is mounted around the outside end of the spindle (26) between the housing (21) and the adjustable body (51) of the screw feed assembly such that a screwdriver (22) to be mounted in the spindle (26) passes through the spring (52).

The ratchet assembly includes a ratchet wheel (53), an axle (54), a driver (55) and a pawl (56). The ratchet wheel (53) and the driver (55) are mounted on the axle (54) in the adjustable body (51). The ratchet wheel (53) is adapted to engage heads of screws sequentially mounted on a strip and has a series of teeth (531) formed circularly around the axle (54) on a side surface of the ratchet wheel (53). The driver (55) has a series of teeth (551) formed circularly around the axle (54) corresponding to the teeth of the ratchet wheel (53) to pivot and rotate the ratchet wheel (53) an one-directional increment to feed a collated screw. The pawl (56) stops the ratchet wheel (53) in a position to drive an indexed collated screw and allows the ratchet wheel (53) to rotate in only one direction.

The axle (54) has an enlarged head (541) and a stepped shrank (542), and the axle (54) is slidably mounted in the adjustable body (51) from the right sidewall to left sidewall. The driver (55) has a guide pin (57) and is mounted between the left sidewall of the adjustable body (51) and the ratchet wheel (53). The guide pin (57) protrudes out of the left sidewall of the adjustable body (51) into the guide slot (41) in the bracket (40). A leaf spring (58) is mounted between the driver (55) and the left sidewall of the adjustable body (51) to press the driver (55) against the ratchet wheel (53).

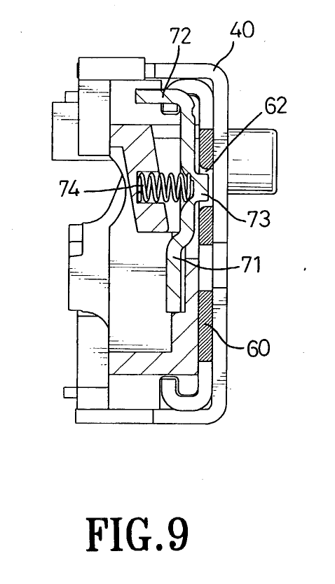

With reference to FIGS. 1 and 9, the screw length assembly is attached to and between the right sidewall of the adjustable body (51) and the bracket (40). The screw length assembly includes an adjustment standoff (60), a positioning latch (71) and a spring (74). The adjustment standoff (60) has a guide channel (61), a series of positioning holes (62), an outside end, an inside end and a screw slot (63). The axle (54) passes through and slides in the guide channel (61). The positioning holes (62) are defined in the adjustment standoff (60) and arranged along a straight line. The screw slot (63) is defined in the outside end of the adjustment standoff (60) and corresponds to the tip of the screwdriver (22).

The positioning latch (71) has a top corresponding to the top of the adjustable body (51), and a tab (72) is formed on the top of the positioning latch (71). A stub (73) is formed on the positioning latch (71) corresponding to the positioning holes (62) in the adjustment standoff (60). The stub (73) is selectively inserted and held in one of the positioning holes (62). A spring (74) is mounted between the positioning latch (71) and the right sidewall of the adjustable body (51) and presses the positioning latch (71) so the stub (73) is held in one positioning hole (62).

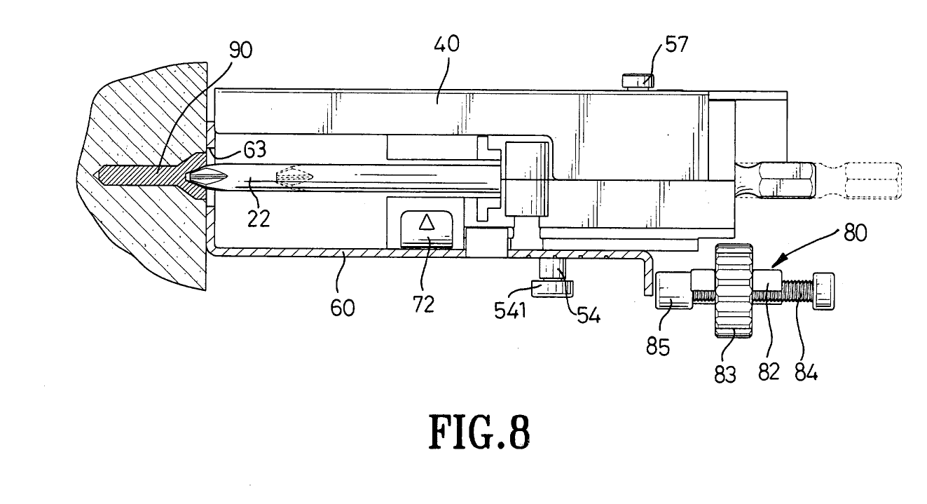

With reference to FIGS. 1 and 8, the screw depth adjustment assembly (80) is mounted in the body (10) corresponding to the inside end of the adjustment standoff (60). The screw depth adjustment assembly (80) includes a holder (82), an adjustment wheel (83), a bolt (84) and a stop (85). A hole (81) is defined in the body (10) to allow a user to turn the adjustment wheel (83). The adjustment wheel (83) is mounted on the bolt (84). The bolt (84) has two ends and an enlarged head (not numbered) formed at one end of the bolt (85) and is adjustably mounted inside the holder (82). The stop (85) is attached to the other end of the bolt (85) and faces the inside end of the adjustment standoff (60).

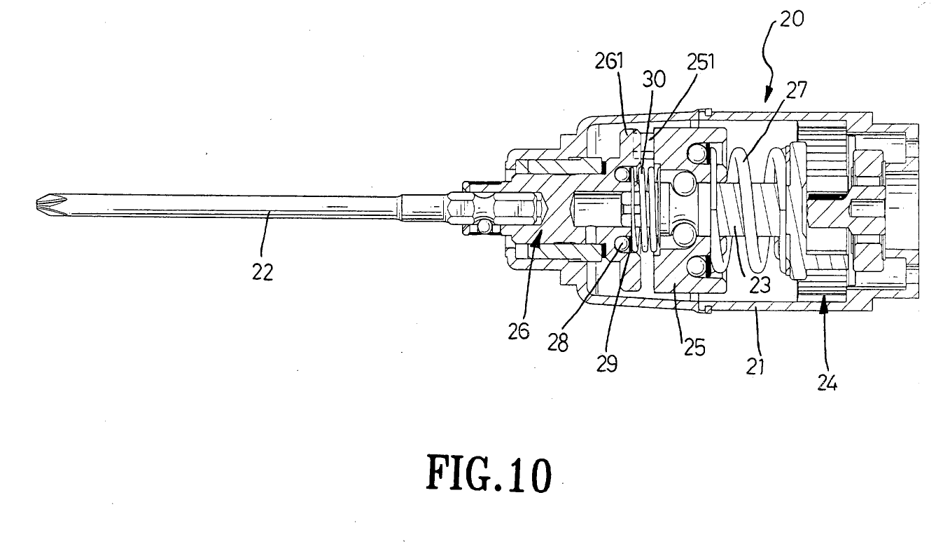

With reference to FIGS. 3, 8 and 10, the operator squeezes the trigger (12) to rotate the drive shaft (131) of the motor (13), and the drive shaft (131) rotate the transmission shaft (23). The drive wheel (25) rotates freely with the transmission shaft (23) when no axial load is applied to the outer end of the spindle (26). Because the biasing member (30) keeps the spindle (26) and the drive wheel (25) separated, the drive wheel (25) will not rotate the spindle (26). The screwdriver (22) installed in the spindle (26) will not rotate so the screw gun is safe even when the trigger (12) is squeezed.

Clearance between the screw slot (63) in the adjustment standoff (60) and the adjustable body (51) must be adequate to accommodate screws (90) of a specific length. The clearance between the screw slot (63) in the adjustment standoff (60) and the adjustable body (51) is adjusted by disengaging the adjustment standoff (60) from the adjustable body (51) and moving the adjustment standoff (60) to a position relative to the adjustable body (51) that provides adequate clearance for a specific screw (90). The adjustment standoff (60) is disengaged from the adjustable body (51) by pressing the tab (72) toward the spring (74) so the stub (73) on the positioning latch (71) disengages from the positioning hole (62). When the adjustment standoff (60) is in position to provide adequate clearance relative to the adjustable body (51), the tab (72) is released so the stub (73) can be held in the corresponding positioning hole (62).

With a screw (90) indexed between the screw slot (63) and the adjustable body (51), pressing the outside end of the adjustment standoff (60) against a workpiece (91) pushes the screw gun toward the workpiece (91). The adjustable body (51) in the screw feed assembly slides on the bracket (40) into the body (10) and compresses the spring (52). A restitution force of the spring (52) is created in the spring (52). Pressing the screw gun further toward the workpiece (91) causes the tip of the screwdriver (22) to touch and engage the screw (90). Squeezing the trigger (12) causes the drive wheel (25) to rotate. As the screw gun is pushed toward the workpiece (91), the screwdriver (22) pushes the spindle (26) toward the rotating drive wheel (25). When the drive blocks (251) on the drive wheel (25) engage the drive wings (261) on the spindle (26), the drive wheel (25) rotates the spindle (26) and the attached the screwdriver (22) that drives the screw (90) into the workpiece (91).

In some applications, the screw (90) does not need to screw totally into the workpiece (91), the operator can turn the adjustment wheel (83) of the screw depth adjustment assembly to axially move the stop (85) toward the inside end of the adjustment standoff (60) with a specific movement. Thus, when the adjustable body (51) moves toward the body (10), the inside end of the adjustment standoff (60) will abut the stop (83) to stop the adjustable body (51) moving. The screw (90) will retain a specific length exposed out of the workpiece (91) and the specific length is equal to the specific movement. When the screwing operation has finished, the operator should not release the trigger (12). The restitution force of the spring (52) pushes the adjustable body (51) and disengages the drive wheel (25) from the spindle (26), and the screwdriver (22) stops rotating. Meanwhile, the drive wheel (25) is still rotated by the transmission shaft (23) when no axial load is applied.

With reference to FIGS. 2, 3 and 6, the screw gun uses collated screws (92) and automatically feeds and indexes another screw (90). When the adjustable body (51) moves toward the body (10), the guide pin (57) of the driver (55) slides along the guide slot (41) in the bracket (40). The driver (55) rotates the ratchet wheel (53), which draws the next collated screw (92) into place. When indexed, a collated screw (92) is aligned with the tip of the screwdriver (22) and can be screwed by the screwdriver (22).

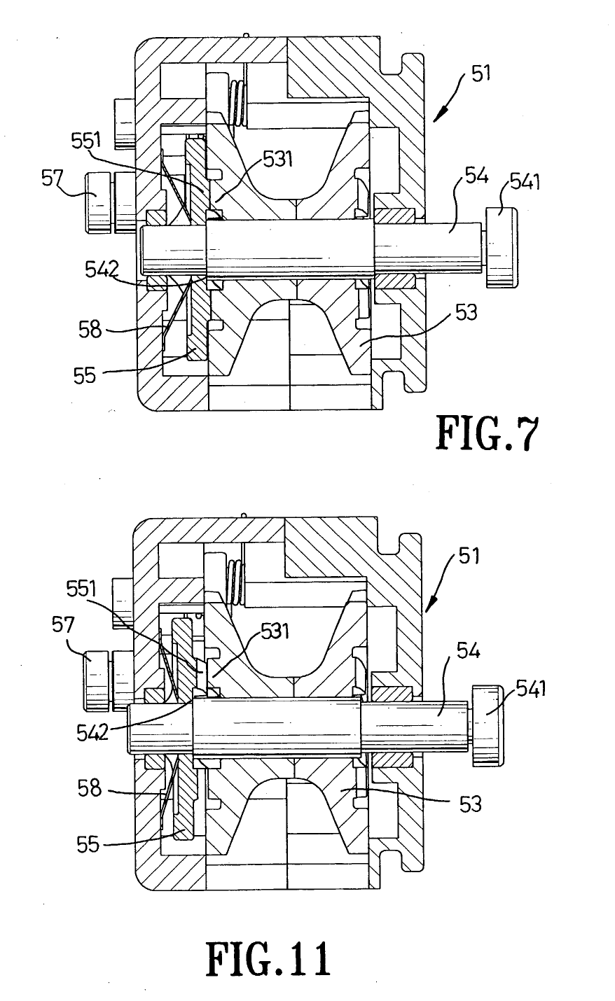

With reference to FIGS. 7 and 11, the collated screws (92) may be fed abnormal and needs to be drawn to a correct position. It is not easy to draw the collated screws (92) to the correct position when the driver (55) engages the ratchet wheel (53). The operator presses the enlarged head (541) of the axle (54) to disengage the driver (55) from the ratchet wheel (53) to draw the collated screws (92) smoothly. After the operator releases the axle (54), the leaf spring (58) pushes the driver (55) to engage the ratchet wheel (53) so the driver (55) can rotate the ratchet wheel (53).

The clutch assembly prevents the operator from being injured when the trigger (12) is inadvertently squeezed while the operator is touching the screwdriver (22). Furthermore, the operator does not need to squeeze and release the trigger repeatedly as continuous screwing.

The screw gun in accordance with the present invention is safe and convenient for an operator to use since the operator can continuously drive screws into an object. The screw gun also increases efficiency and saves time.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A screw gun to feed and drive collated screws and the screw gun comprising:
a body with an opening, a right side and a left side;
a power assembly mounted in the body, and the power assembly comprising
a switch; and
a motor with a drive shaft electrically connected to the switch;
a screwdriver assembly comprising
a housing with a rear end and a front end mounted in the body corresponding to the motor, the rear end facing toward the motor and the front end opposite from the rear end;
a transmission assembly rotatably mounted in the housing, and the transmission assembly comprising
a transmission shaft rotated by the drive shaft of the motor in the power assembly;
a drive wheel slidably mounted on the transmission shaft, and the drive wheel having a drive face facing toward the front end of the housing and at least one drive block formed on the drive face of the drive wheel; and
a spindle with an inside end and an outside end rotatably and slidably mounted in the front end of the housing and at least one drive wing formed on the inside end of the spindle, and each drive wing engaging one of the at least one drive block, and a multi-faceted hole defined in the outside end of the spindle;
a screwdriver with a tip and a multi-faceted end, and the multi-faceted end in the multi-faceted hole on the outside end of the spindle; and
a clutch assembly with a biasing member mounted between the drive wheel and the spindle, the biasing member separating the at least one drive block on the drive wheel from the at least one drive wing on the spindle;
a bracket securely mounted in the opening of the body; and
a screw feed assembly comprising
an adjustable body with a top, a right sidewall and a left sidewall slidably mounted in the bracket and adapted to feed collated screws;
a coil spring mounted around the outside end of the spindle between the adjustable body and the housing; and
a screw length assembly slidably attached to and between the right sidewall of the adjustable body and the bracket.

2. The screw gun as claimed in claim 1, wherein the power assembly further comprises
a power source of electricity electrically connected to the switch, and the power source adapted to electrically connect to a battery.

3. The screw gun as claimed in claim 1, wherein
a concentric annular recess is defined in the inside end of the spindle; and
the clutch assembly further comprising
ball bearings mounted in the concentric annular recess in the spindle; and
a washer mounted between the ball bearings and the biasing member.

4. The screw gun as claimed in claim 2, wherein
a concentric annular recess is defined in the inside end of the spindle; and
the clutch assembly further comprising
ball bearings mounted in the concentric annular recess in the spindle; and
a washer mounted between the ball bearings and the biasing member.

5. The screw gun as claimed in claim 3, wherein the biasing member is a spring.

6. The screw gun as claimed in claim 1, wherein
the bracket includes two half-bodies mounted in the right side and left side of the body respectively, and a guide slot is defined in one of the half-bodies in the left side of the body;
the adjustable body has two half-shells, and the right sidewall of the adjustable body corresponds to the right side of the body and the left sidewall of the adjustable body corresponds to the left side of the body;
the screw feed assembly further comprising
a ratchet assembly mounted in the adjustable body and housed in the two half-shells of the adjustable body, and the ratchet assembly comprising
an axle with an enlarged head and a stepped shrank is slidably mounted in the adjustable body from the right sidewall to the left sidewall of the adjustable body;
a ratchet wheel rotatably mounted in the body on the axle and adapted to hold and feed a strip with collated screws;
a driver with a guide pin pivotally mounted between the left sidewall of the adjustable body and ratchet wheel, and the guide pin extending out of the left sidewall of the adjustable body and held in the guide slot in the bracket;
a pawl pivotally mounted in the adjustable body; and
a spring mounted between the driver and the left sidewall of the adjustable body and adapted to press the driver to engage the ratchet wheel;
whereby the pivot pin is pressed and the stepped shaft of the pivot pin abuts the driver to disengage the ratchet wheel to draw the strip out smoothly.

7. The screw gun as claimed in claim 6, wherein the screw length assembly comprises
an adjustment standoff having
an outside end out of the body;
an inside end in the body;
a guide channel defined in the adjustment standoff to allow the axle of the ratchet assembly to pass through and slide in the guide channel;
a series of positioning holes defined in the adjustment standoff and arranged along a straight line; and
a screw slot corresponding to the tip of the screwdriver defined in the outside end of the adjustment standoff;
a positioning latch having a top, a tab and a stub, the top of the positioning latch corresponding to the top of the adjustable body, and the tab formed on the top of the positioning latch, the stub formed on the positioning latch corresponding to the positioning holes in the adjustment standoff; and
a spring mounted between the positioning latch and the right sidewall of the adjustable body;
wherein the stub is inserted in one of the positioning holes and held in the positioning hole.

8. The screw gun as claimed in claim 7 further comprising
a screw depth adjustment assembly mounted in the body corresponding to the inside end of the adjustment standoff, and the screwing depth assembly comprising
a holder;
a bolt with two ends and an enlarged head, the enlarged head formed at one end of the bolt and the bolt rotatably mounted in the holder;
a adjustment wheel mounted on the bolt; and
a stop attached to the other end of the bolt and corresponding to the inside end of the adjustment standoff;
wherein a hole is defined in the body to allow an operator to turn the adjustment wheel.

9. The screw gun as claimed in claim 8, wherein the power supply assembly further comprises
a power source of electricity electrically connected to the switch, and the power source adapted to electrically connect to a battery.

10. The screw gun as claimed in claim 9, wherein
a concentric annular recess is defined in the inside end of the spindle; and
the clutch assembly further comprising
ball bearings mounted in the concentric annular recess in the spindle; and
a washer mounted between the ball bearings and the biasing member.

11. The screw gun as claimed in claim 10, wherein the biasing member is a spring.

12. The screw gun as claimed in claim 8, wherein the power supply assembly further comprises
a power source of electricity electrically connected to the switch, and the power source adapted to electrically connect to an electric outlet.
